(19) United States
(12) Patent Application Publication
(10) Pub. No.: US 2019/0316597 A1
(43) Pub. Date: Oct. 17, 2019

(54) BLOWER HOUSING

(71) Applicant: LAU Holdings, LLC, Dayton, OH (US)

(72) Inventor: Michael Brendel, Centerville, OH (US)

(21) Appl. No.: 15/970,514

(22) Filed: May 3, 2018

Related U.S. Application Data
(60) Provisional application No. 62/657,535, filed on Apr. 13, 2018.

(51) Int. Cl. F04D 29/30; F04D 29/28; F04D 17/10

(52) U.S. Cl. CPC F04D 29/30; F05D 2240/304; F04D 17/10; F04D 29/282

(57) ABSTRACT

A blower includes an impeller configured to be turned about a rotational axis of the impeller, and a housing. The housing includes a wrapper which curves in a circumferential direction about the rotational axis along a spiral contour. The housing also includes a side wall coupled to an edge of the wrapper such that an inner transition region between the side wall and the wrapper, which at least partially forms a flow path of the blower between an inlet and an outlet of the blower, is rounded and not pointed.

### CROSS REFERENCE TO RELATED APPLICATIONS

This application claims priority from and the benefit of U.S. Provisional Application Ser. No. 62/657,535, entitled “BLOWER HOUSING,” filed Apr. 13, 2018, which is hereby incorporated by reference in its entirety for all purposes.

### BACKGROUND

The present disclosure relates generally to heating, ventilation, and air conditioning (HVAC) systems and, more particularly, to a housing of a blower of the HVAC system.

A wide range of applications exist for HVAC systems. For example, residential, light commercial, commercial, and industrial systems are used to control temperatures and air quality in residences and buildings. Generally, HVAC systems may circulate a fluid, such as a refrigerant, through a closed loop between an evaporator coil where the fluid absorbs heat and a condenser where the fluid releases heat. The fluid flowing within the closed loop is generally formulated to undergo phase changes within the normal operating temperatures and pressures of the system, so that quantities of heat can be exchanged by virtue of the latent heat of vaporization of the fluid. A blower may move air over the coils of the heat exchanger(s) in order to condition the air. Blowers may also be incorporated in other aspects of the HVAC system.

It is now recognized that a traditional blower may include a structure susceptible to causing secondary air flows therein, which reduces an efficiency of the traditional blower. Accordingly, improved blowers for HVAC systems are desired.

### SUMMARY

The present disclosure relates to a blower. The blower includes an impeller configured to be turned about a rotational axis of the impeller, and a housing. The housing includes a wrapper which curves in a circumferential direction about the rotational axis. The housing also includes a side wall coupled to an edge of the wrapper such that an inner transition region between the side wall and the wrapper, which at least partially forms a flow path of the blower between an inlet and an outlet of the blower, is rounded and not pointed.

The present disclosure also relates to a blower having an impeller configured to be turned about a rotational axis of the impeller. The blower also includes a housing, where the housing includes a wrapper having an edge that curves in a circumferential direction about the impeller and along a spiral contour. The housing also includes a side wall coupled to the edge of the wrapper. The wrapper includes an outer ridge extending along the edge and forming an inner recess therein. The side wall includes a flange, which is disposed in the outer ridge to couple the side wall to the wrapper such that an inner transition region between the side wall and the wrapper, which at least partially forms a flow path of the blower, is rounded and not pointed.

The present disclosure also relates a heating, ventilation, and air conditioning (HVAC) system having a blower. The blower includes an impeller configured to be turned about a rotational axis of the impeller. The blower also includes a housing comprising a wrapper that curves in a circumferential direction about the impeller. The housing also includes a side wall coupled to an edge of the wrapper such that an inner transition region between the side wall and the wrapper, which at least partially forms a flow path of the blower, is rounded and not pointed. The side wall, the inner transition region, or both form a U-shaped cross-sectional profile with respect to a cross-section having the rotational axis disposed therein.

### DRAWINGS

FIG. 1 is a perspective view a heating, ventilation, and air conditioning (HVAC) system for building environmental management, in accordance with embodiments described herein;

FIG. 2 is a perspective view of the packaged HVAC unit of the HVAC system of FIG. 1, in accordance with embodiments described herein;

FIG. 3 is a perspective view of a residential HVAC system, in accordance with embodiments described herein;

FIG. 4 is a schematic diagram of a vapor compression system that may be used in the packaged HVAC system of FIG. 2 and the residential HVAC system of FIG. 3, in accordance with embodiments described herein;

FIG. 5 is a perspective view of a blower for use in any of the HVAC systems of FIGS. 1-4, in accordance with embodiments described herein;

FIG. 6 is a cross-sectional view of the blower of FIG. 5, taken along lines 6-6 in FIG. 5, in accordance with embodiments described herein; and

FIG. 7 is a cross-sectional view of the blower of FIG. 5, taken along lines 7-7 in FIG. 5, in accordance with embodiments described herein;

FIG. 8 is a cross-sectional view of a blower for use in any of the HVAC systems of FIGS. 1-4, in accordance with embodiments described herein;

FIG. 9 is a cross-sectional view of a blower for use in any of the HVAC systems of FIGS. 1-4, in accordance with embodiments described herein;

FIG. 10 is a cross-sectional view of a blower for use in any of the HVAC systems of FIGS. 1-4, in accordance with embodiments described herein; and

FIG. 11 is a block diagram of a method of manufacturing a blower for use in any of the HVAC systems of FIGS. 1-4, in accordance with embodiments described herein.

### DETAILED DESCRIPTION

The present disclosure is directed toward heating, ventilation, and air conditioning (HVAC) systems and, more particularly, toward a housing of a blower of the HVAC system. In particular, the presently disclosed blower may include a housing having rounded flow path surfaces configured to efficiently convey an air flow through the blower, in accordance with the description below.

A traditional blower housing may include several pieces of sheet metal which are shaped and joined to define a flow path between the traditional blower housing and an impeller of the traditional blower, where the impeller is rotated to draw an air flow into the flow path. The traditional blower housing may include, along the flow path of the traditional blower, pointed inner transition regions, such as pointed seams/regions, between various pieces of the sheet metal. It is now recognized that such pointed inner transition regions may cause, proximate to the pointed inner transition regions, secondary air flows within the traditional blower. The secondary air flows may reduce an efficiency of the traditional blower, since the secondary air flows may work against a primary air flow through the flow path of the traditional blower.

In accordance with present embodiments, a blower includes a housing having rounded inner transition regions between pieces of sheet metal forming the housing, and along a flow path of the blower. For example, the housing may include a wrapper which is curved about the impeller of the blower. That is, the wrapper may extend, in a circumferential direction about a rotational axis of the impeller, along a helical or spiral contour which spirals away from the rotational axis. In one embodiment, sheet metal utilized to form the wrapper may include a generally rectangular shape, which is curved about the impeller in the above-described manner to form the flow path between the impeller and the wrapper. Thus, the wrapper includes opposing edges which follow the helical or spiral curvature of the wrapper about the rotational axis of the impeller.

The housing may also include opposing side walls coupled, respectively, to the opposing edges of the wrapper, whereby the opposing side walls define outer edges of the flow path. In other words, each opposing side wall extends between a respective edge of the wrapper and an intake opening for the impeller. Each side wall may include a U-shaped or partial circle profile extending between the wrapper and the impeller, with respect to a cross-section of the blower taken to include the rotational axis of the impeller wholly within the cross-section. In other words, the U-shaped cross-sectional profile may be extruded along the curvature of the edge of the wrapper, although the U-shaped cross-sectional profile may change as the U-shaped cross-sectional profile is extruded along the curvature of the edge of the wrapper, such that U-shaped cross-sectional profile includes a gradually widening mouth along the extrusion. It should be noted that “extrude” used in accordance with the present disclosure refers to generating a three-dimensional (3-D) shape from a two-dimensional (2-D) cross-section by extending the 2-D cross-section along a contour. Of course, as noted above, the 2-D cross-section may change as it is extruded to form the 3-D shape, such as by widening a mouth of the U-shaped cross-sectional profile.

As noted above, the side wall includes a U-shaped profile with respect to a cross-section of the blower taken to include the rotational axis therein. With respect to the cross-section taken to include the rotational axis of the impeller therein, an inner transition region may extend along the flow path from the side wall, through a juncture between the side wall and the wrapper, and through the wrapper. In accordance with the present disclosure, the inner transition region may be rounded or curved, and not pointed. That is, the inner transition region may include a smooth curvature, and at certain cross-sections taken along the rotational axis, the smooth curvature may include a U-shaped or partial circle profile.

The inner transition region, like the wrapper and the side wall forming the inner transition region, extends about the impeller. In some embodiments, the wrapper spirals, along a circumferential direction about the rotational axis of the impeller, radially away from the impeller as the wrapper approaches an air output opening of the blower, such that the profile of the inner transition region changes. That is, as the inner transition region approaches the air output opening, the curvature of the transition region may become more “obtuse,” meaning that the curvature may become less acute. For example, in embodiments where the curvature of the inner transition region forms U-shaped cross-sectional profiles taken at various locations along the flow path, the U-shaped cross-sectional profiles may become gradually more obtuse as the flow path approaches the air output opening, meaning that the U-shaped cross-sectional profile includes a gradually widening mouth such that the arms of the U-shape are pushed apart as the flow path approaches the air output opening.

Further, an opening may be disposed in one or both of the opposing side walls of the housing, where the opening is pierced by the rotational axis of the impeller. Thus, the side wall extends along the edge of the wrapper and forms an opening radially inward from the side wall, where the opening is pierced by the rotational axis of the impeller. However, the side wall may not totally enclose the housing. Instead, an air intake opening of the housing may be disposed within the side wall, or the side wall may curve about the air intake opening, where the air intake opening is fluidly coupled to the impeller. A motor may turn the impeller about the rotational axis, which causes the impeller to draw air through the air intake opening and into the flow path of the blower. Thus, the flow path, which receives the air drawn through the air intake opening, is formed between the impeller, the wrapper of the housing, and the opposing side walls of the housing. As noted above, the side walls and wrapper are joined such that inner transition regions therebetween, and along the flow path, are rounded and not pointed. The curvature of the inner transition region may be smooth and/or continuous. By including the smooth, rounded transition regions along the flow path, secondary air flows are reduced or negated, and an efficiency of the blower is improved over traditional embodiments. For example, since the primary air flow is affected less by secondary air flows in the disclosed blower than in traditional blowers, less power is required for the disclosed blower to achieve the desired movement of air. These and other features will be described in detail below with reference to the drawings.

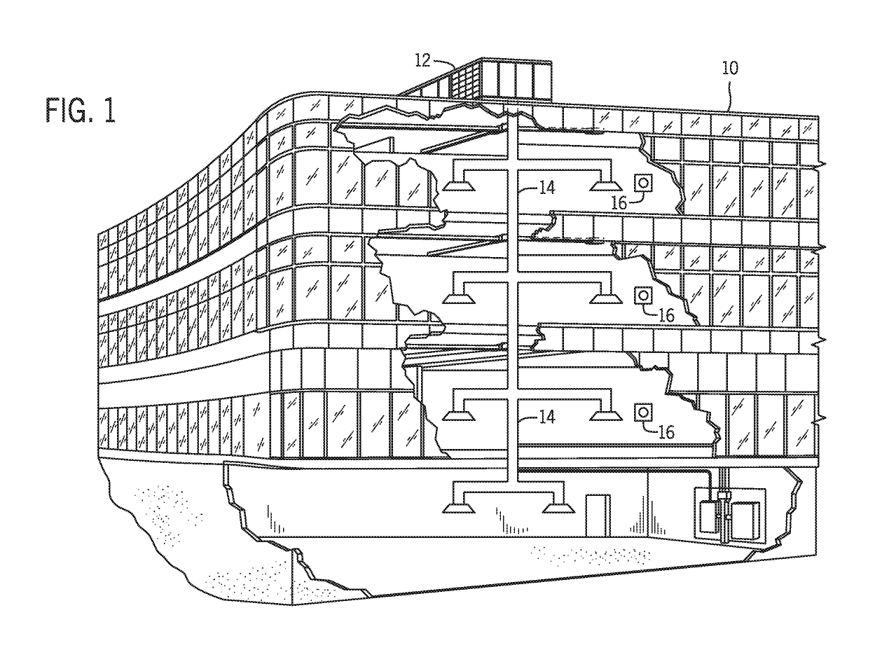

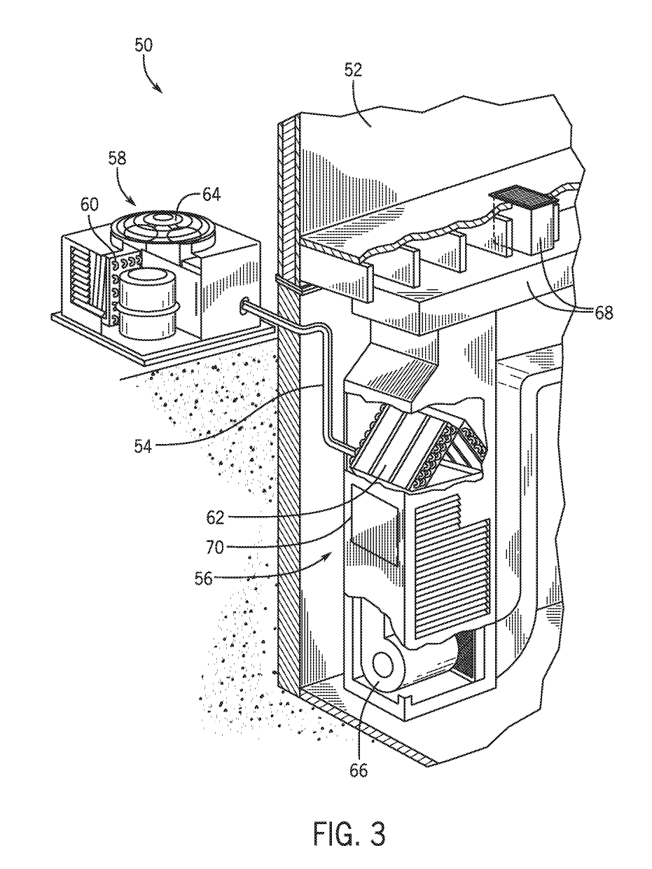

Turning now to the drawings, FIG. 1 illustrates a heating, ventilation, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

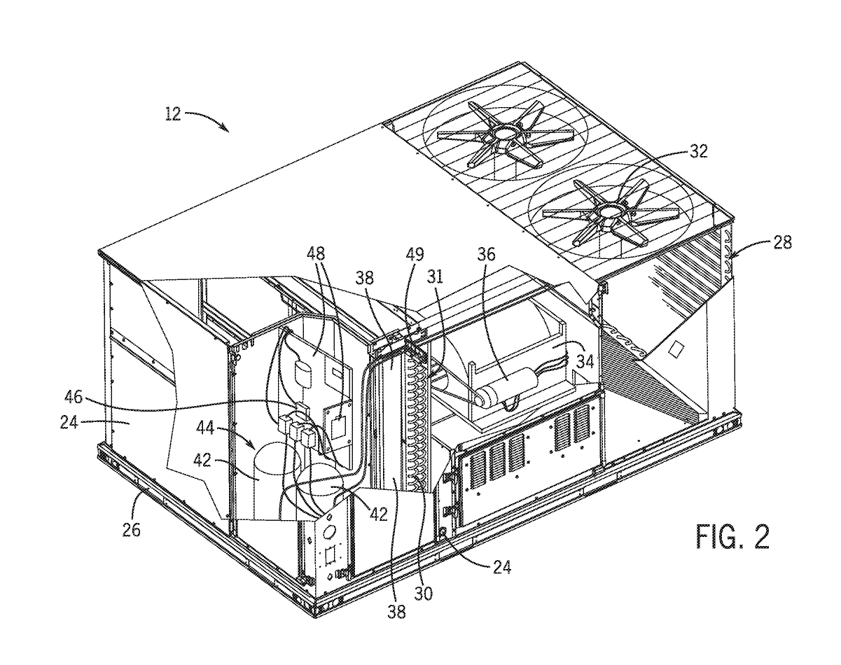

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant through the heat exchangers 28 and 30. For example, the refrigerant may be R-410A. The tubes may be of various types, such as multichannel and/or microchannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or the set point plus a small amount, the residential heating and cooling system 50 may become operative to refrigerate additional air for circulation through the residence 52. When the temperature reaches the set point, or the set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

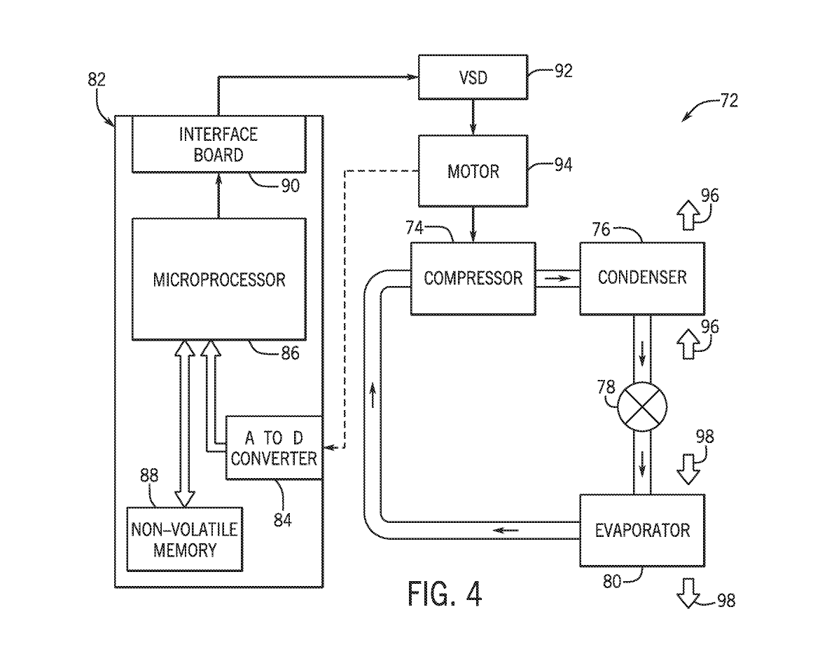

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications. Further, any of FIGS. 1-4 may include, in accordance with an aspect of the present disclosure, a blower having a housing that includes rounded inner transition regions between pieces of sheet metal forming the housing, and along a flow path of the blower. That is, the “rounded inner transition regions” between pieces of sheet metal forming the housing refers to rounded inner surfaces which form the flow path of the blower. The rounded transition regions may include smooth curvatures which reduce or negate secondary flows along the flow path, thereby improving an efficiency of the blower over traditional embodiments. For example, since the primary air flow is affected less by secondary air flows in the disclosed blower than in traditional blowers, less power is required for the disclosed blower to achieve the desired movement of air.

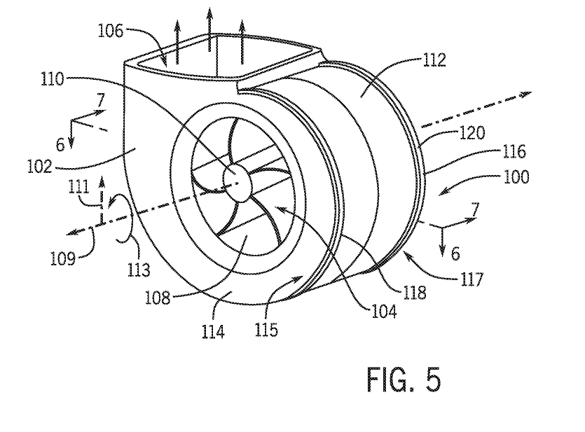

FIG. 5 is a perspective view of a blower 100 for use in any of the HVAC systems of FIGS. 1-4. In the illustrated embodiment, the blower 100 includes a housing 102, an air intake opening 104 through a portion of the housing 102, an air output opening 106 through a portion of the housing 102, and an impeller 108. It should be noted that the air intake opening 104 may extend through opposing sides of the blower 100, such that the impeller 108 draws air into the blower 100 through the air intake opening 104 on either side of the blower 100, as will be appreciated in view of the description below. In embodiments whereby the blower 100 includes the air intake opening 104 extending through opposing sides of the housing 102, the air intake opening 104 may be referred to as an air intake passage.

For example, the impeller 108 is positioned within a portion of the housing 102, and is configured to be turned about a rotational axis 109 of the impeller 108. A motor 110 may drive the impeller 108 into rotation about the rotational axis 109. Rotation of the impeller 108, and blades thereof, may cause air to be drawn into the blower 100 through the air intake opening 104, which extends through at least one side of the blower 100. The air may be directed through a flow path internal to the blower 100, and defined between the impeller 108 and the housing 102 of the blower 100. The air may be directed from the flow path of the blower 100 through the air output opening 106 of the blower 100, such as toward other areas of an associated HVAC system.

In accordance with present embodiments, the blower 100 illustrated in FIG. 5 includes a wrapper 112 which extends about the impeller 108. For example, the wrapper 112 may include a generally rectangular shape which extends about the impeller 108. In some embodiments, the wrapper 112 may be sheet metal having a generally rectangular shape which extends about the impeller 108. It should be noted that the impeller 108 in the illustrated embodiment is radially centered on the rotational axis 109, but that the wrapper 112 may include at least a segment which spirals outwardly from the rotational axis 109 as the wrapper 112 approaches the air output opening 106, with respect to a direction of air flow through the flow path. In other words, the wrapper 112 may include a portion which is curved in a circumferential direction 113 about the rotational axis 109 along a helical or spiral contour. The wrapper 112 may extend along the helical or spiral contour in the circumferential direction 113 such that the wrapper 112 gradually moves away from the impeller 108, with respect to a radial direction 111, as the wrapper 112 approaches the air output opening 106. Thus, a radial dimension of the flow path, measured in the radial direction 111 perpendicular to the rotational axis 109, may increase in size as the wrapper 112 and flow path approach the air output opening 106.

The blower 100 in the illustrated embodiment also includes opposing side walls 114, 116 which are coupled to opposing edges 115, 117 of the wrapper 112. The opposing side walls 114, 116 may be curved, as shown, such that the flow path internal to the blower 100 includes curved inner surfaces. That is, as shown, each of the side walls 114, 116 includes a generally U-shaped cross-sectional profile, where the U-shaped cross-sectional profile extends between the wrapper 112 and the impeller 108. The U-shaped cross-sectional profile is extruded about the impeller 108 along the edge 115 of the wrapper 112, namely, along the helical or spiral contour about the circumferential direction 113, as noted above. However, as previously described, the U-shaped profile may change along the extrusion, such that the U-shaped profile includes a wider mouth adjacent the air output opening 106 than at upstream locations. In other words, as will be appreciated in view of later discussion, the above-referenced U-shaped cross-sectional profile may change in shape as the side wall 114 extends, or is extruded, about the impeller 108, since the wrapper 112 spirals away from the rotational axis 109 as the wrapper 112 approaches the air output opening 106. The inner curvature of the side wall 114 toward the impeller 108, which at least partially defines the flow path of the blower 100, may be a smooth, rounded curve at cross-sections taken to include the rotational axis 109 wholly therein, and may compliment the inner surface of the wrapper 112, as will be appreciated in view of the description below.

For example, the wrapper 112 may include outer ridges 118, 120 adjacent to the opposing side walls 114, 116. The outer ridge 118 may form an inner recess which receives a flange of the sidewall 114. Likewise, the outer ridge 120 may form an inner recess which receives a flange of the sidewall 116. The flanges of the opposing side walls 114, 116 may be crimped within the respective outer ridges 118, 120 of the wrapper 112, thereby coupling the opposing side walls 114, 116 to the wrapper 112. Alternatively, the wrapper 112 may be welded to the opposing side walls 114, 116. Further, in some embodiments, the side walls 114, 116 may include the outer ridges 118, 120, and the wrapper 112 may include the flanges. By way of the above configuration, an inner transition region between the wrapper 112 and the side wall 114, which forms a portion of the flow path, is rounded and not pointed. That is, the internal transition region extending from an inner surface of the wrapper 112, across the juncture between the wrapper 112 and the side wall 114, and through an inner surface of the side wall 114 may be rounded and not pointed. In other words, the juncture between the inner surface of the wrapper 112 and the inner surface of the side wall 114 may not be pointed or square. Likewise, the inner transition region between the wrapper 112 and the opposing side wall 116 may curve from the wrapper 112, through the juncture between the wrapper 112 and the side wall 116, and through the side wall 116. The side walls 114, 116, which form a portion of the transition regions, may include distal ends which curl inwardly toward the impeller 108. By including the curved inner transition regions via the wrapper 112 and side walls 114, 116 as noted above, the flow path includes rounded and not pointed surfaces, which reduces or negates secondary air flows adjacent the transition regions. These and other features will be described in detail below, with reference to cross-sectional drawings illustrating the flow path and curved internal surfaces referenced above.

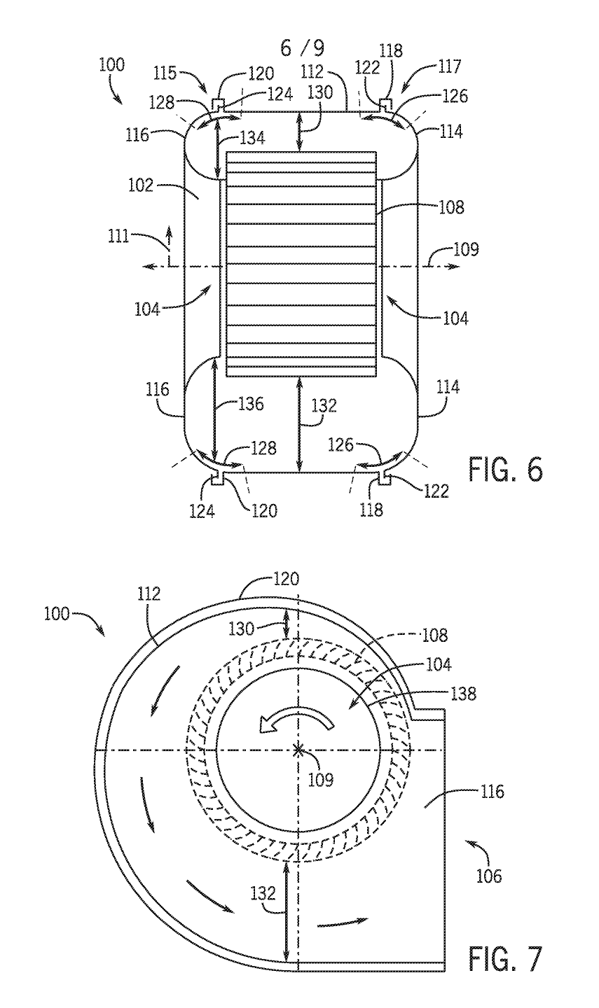

FIG. 6 is a cross-sectional view of the blower 100 of FIG. 5, taken along lines 6-6 in FIG. 5. The illustrated cross-section is taken to include the rotational axis 109 of the impeller 108 disposed therein. In other words, the cross-section extends through a center of the impeller 108, such that the rotational axis 109 is disposed within the cross-section. It should be noted that reference herein to a “cross-section taken to include the rotational axis 109 therein” means that the rotational axis 109 extends from one region of the cross-section to another region of the cross-section, as opposed to merely piercing through the cross-section.

In the illustrated embodiment, the air intake opening 104 may extend through one or both of the opposing side walls 114, 116, as previously described, and may be fluidly coupled with the impeller 108. In the illustrated embodiment, the blower 100 includes the opposing side walls 114, 116 coupled to edges 115, 117 of the wrapper 112. For example, as previously described, the wrapper 112 may include the opposing outer ridges 118, 120, which each form an inner recess. The outer ridge 118, or an inner recess thereof, receives a flange 122 of the side wall 114, and the other outer ridge 120, or an inner recess thereof, receives a flange 124 of the other side wall 116. The outer ridges 118, 120 may be crimped such that the flanges 122, 124 are fixed within the respective outer ridges 118, 120, thereby coupling the opposing side walls 114, 116, respectively, to the wrapper 112. Thus, as shown, an inner transition region 126 between the side wall 114 and the wrapper 112 is rounded and not pointed. In other words, a smooth curve extends through the inner transition region 126. Further, an inner transition region 128 between the opposing side wall 116 and the wrapper 112 is also rounded and not pointed. In other words, a smooth curve extends through the inner transition region 128.

It should be noted, as previously described, that the wrapper 112 may spiral away from the rotational axis 109 of the impeller 108 as the wrapper 112 approaches the air output opening (not shown) with respect to a direction of air flow through the blower 100. Thus, a size of a radial dimension of the flow path may increase as the flow path approaches the air output opening (not shown). That is, the flow path of the blower 100 may include a first radial distance 130 measured between the wrapper 112 and an outer surface, or blade tips, of the impeller 108 at a first location within the flow path. The flow path of the blower 100 may include a second radial distance 132 measured between the wrapper 112 and an outer surface, or blade tips, of the impeller 108 at a second location within the flow path, where the second radial distance 132 is larger than the first radial distance 130. Because the radial distances 130, 132 change, a curvature of the opposing side walls 114, 116 may change to accommodate the increase from the smaller radial distance 130 to the larger radial distance 132. That is, the curvature of the opposing side walls 114, 116 adjacent to the larger radial distance 132 is more obtuse than the curvature of the opposing side walls 114, 116 adjacent to the smaller radial distance 130. For example, at the cross-section of the side walls 114, 116 illustrated in FIG. 6, the side walls 114, 116 include generally U-shaped profiles having increasingly obtuse curvature as the side walls 114, 116 approach the air output opening (not shown). Thus, for example, the U-shaped profile of the side wall 116 adjacent the smaller radial distance 130 includes a mouth 134, which is smaller than a mouth 136 of the U-shaped profile adjacent the larger radial distance 132. It is now recognized that the above-described curvature causes a Venturi effect which improves efficiency of the blower 100 over traditional embodiments having squared or pointed internal transitions between portions of the traditional embodiment.

FIG. 7 is a cross-sectional view of the blower 100 of FIG. 5, taken along lines 7-7 in FIG. 5. In the illustrated embodiment, as previously described, the radial distance 132 adjacent the air output opening 106, measured between the impeller 108 and the wrapper 112, is larger than the radial distance 130 at an upstream location. Thus, the flow path may increase in size as the flow path approaches the air output opening 106. The curvature of the side walls may become increasingly more obtuse as the side walls curve about the impeller 108 toward the air output opening 106. Likewise, the wrapper 112 may spiral away from the impeller 108 as the wrapper 112 approaches the air output opening 106. One of the outer ridges 120 of the wrapper 112 is shown in the illustrated embodiment, which forms an inner recess configured to receive a flange of the side wall 116, noting that the inner surface of the side wall 116 is shown in the illustrated embodiment. The side wall 116 extends from the outer ridge 120 toward the impeller 108. For example, the side wall 116 extends from the outer ridge 120 toward a circumferential edge 138 of the side wall 116, where the circumferential edge 138 extends circumferentially about the rotational axis 109 of the impeller 108 and defines the air intake opening 104 of the blower 100.

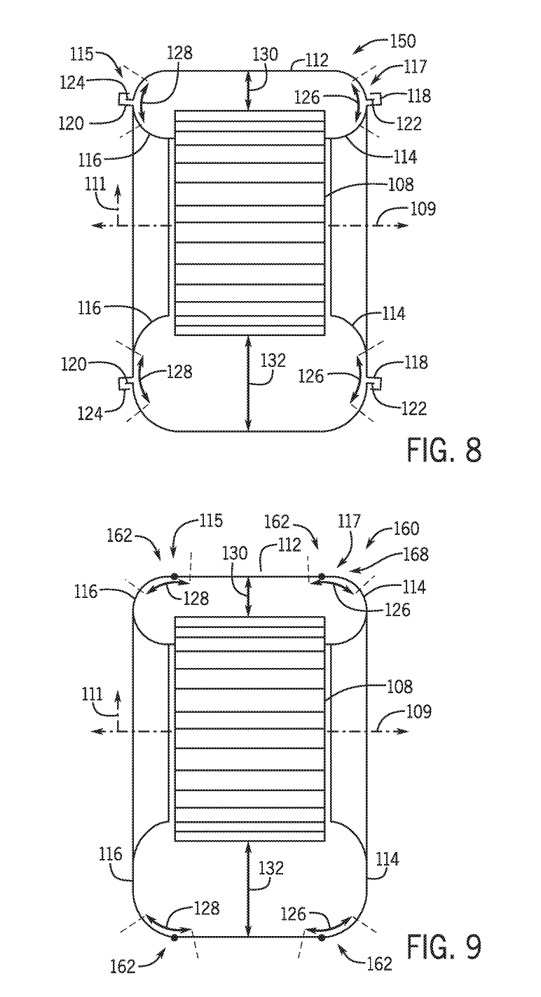

Other techniques and/or structures are also possible for coupling the wrapper 112 with the opposing side walls 114, 116 of the blower 100. FIG. 8 is a cross-sectional view of a blower 150 for use in any of the HVAC systems of FIGS. 1-4. In the illustrated embodiment, the outer ridges 118, 120 which each form an inner recess are disposed on the opposing side walls 114, 116, instead of on the wrapper 112. Further, the flanges 122, 124 are disposed on edges 115, 117 of the wrapper 112 instead of the opposing side walls 114, 116. Thus, in the illustrated embodiment, the flanges 122, 124 of the wrapper 112 extend into the inner recesses formed by the outer ridges 118, 120 of the respective opposing side walls 114, 116. The outer ridges 118, 120 of the respective opposing side walls 114, 116 may be crimped with the flanges 122, 124 disposed in the inner recesses therein, thereby coupling the opposing side walls 114, 116 to the wrapper 112.

Further, in the illustrated embodiment, the inner transition regions 126, 128 are disposed closer to the air intake opening 104, which extends through both side walls 114, 116, than in FIG. 6. Thus, the side walls 114, 116 and the wrapper 112 jointly define the curvature of the transition regions 126, 128 in the illustrated embodiment, whereas in other embodiments, the transition regions 126, 128 may include flat segments of the wrapper 112 and curved segments of the side walls 114, 116. However, the general curvatures which define the flow path of the blower 150 in FIG. 8 are the same as, or similar to, the general curvatures which define the flow path of the blower 100 in FIGS. 6, insomuch as they do not include pointed, squared, or non-smooth flow path surfaces which are susceptible to secondary air flows.

It should be noted that, in any of the preceding illustrations and descriptions thereof, the flanges 122, 124 may be welded to the respective outer ridges 118, 120, as opposed to being crimped within the outer ridges 118, 120. Further, other structures may be utilized in conjunction with welding to facilitate rounded inner transition regions between the side walls 114, 116 and the wrapper 112. For example, FIG. 9 is a cross-sectional view of a blower 160 for use in any of the HVAC systems of FIGS. 1-4. In FIG. 9, the wrapper 112 of the blower 160 is welded directly to the opposing side walls 114, 116 of the blower 160. In other words, the blower 160 does not include the flanges and outer ridges described with respect to FIGS. 5-8. Welds 162 between the wrapper 112 and the opposing side walls 114, 116 couple the wrapper 112 to the opposing side walls 114, 116.

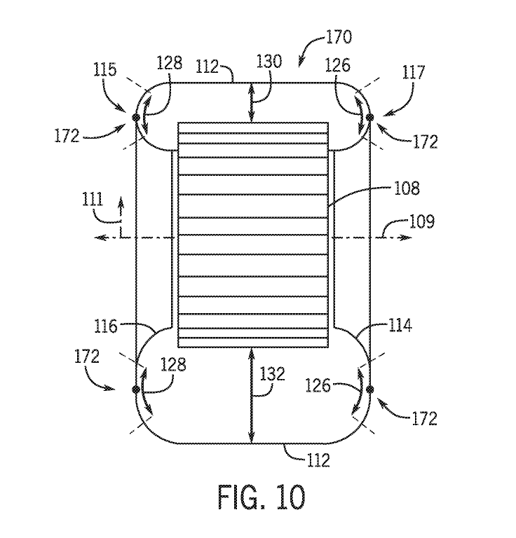

FIG. 10 is a cross-sectional view of a blower 170 for use in any of the HVAC systems of FIGS. 1-4. Like in FIG. 9, in FIG. 10, the wrapper 112 of the blower 170 is welded directly to the opposing side walls 114, 116 of the blower 160. In other words, the blower 160 does not include the flanges and outer ridges described with respect to FIGS. 5-8. Welds 172 between the wrapper 112 and the opposing side walls 114, 116 couple the wrapper 112 to the opposing side walls 114, 116. A location of the welds 172 in FIG. 10 is closer to the air intake opening 104 than a location of the welds 162 in FIG. 9. This is representative of embodiments wherein the inner transition regions 126, 128 between the wrapper 112 and the opposing side walls 114, 116 may include different segments of the wrapper 112 and/or opposing side walls 114, 116 than in previously described embodiments. For example, as previously described, the transition regions 126, 128 in certain embodiments may encompass flat segments of the wrapper 112, and curved segments of the opposing side walls 114, 116. However, in each embodiment, the inner transition regions 126, 128 may not include any pointed seams, regions, or surfaces. In other words, the inner transition regions 126, 128 in presently disclosed embodiments include smooth, round, curved surfaces, as opposed to pointed, squared, non-smooth, or non-round surfaces of traditional embodiments.

It should be noted that the “inner transition regions” 126, 128 referenced with respect to FIGS. 6-10 may include flat and rounded segments, or only rounded segments. In some embodiments, a juncture between the wrapper 112 and the side wall 114 may be disposed between flat segments of the wrapper 112 and the side wall 114, and that the side wall 114 may include the aforementioned U-shaped cross-sectional at a distance away from the juncture between the side wall 114 and the wrapper 112. In such embodiments, “inner transition region” includes at least a portion of the curvature of the U-shaped profile, despite the U-shaped profile being disposed a distance from the juncture.

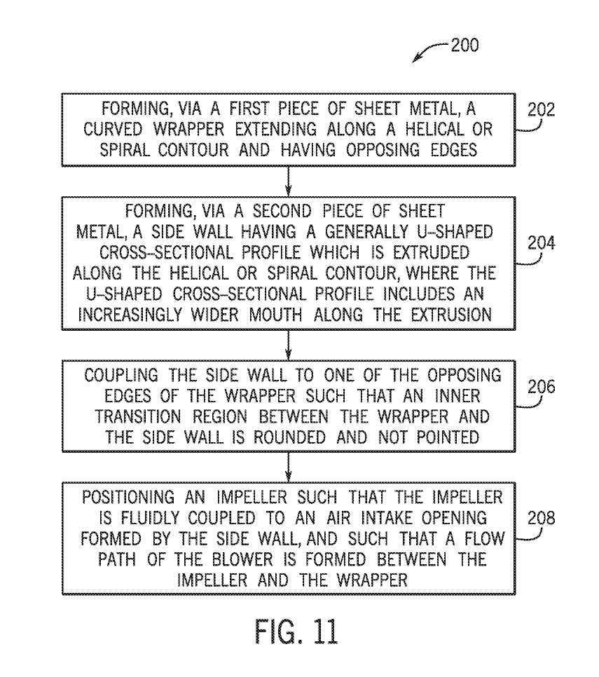

FIG. 11 is a block diagram illustrating a method 200 of manufacturing a blower for use in any of the HVAC systems of FIGS. 1-4. In the illustrated embodiment, the method 200 includes forming (block 202), via a first piece of sheet metal, a curved wrapper having opposing edges, whereby the curvature of the wrapper and the edges follows a spiral or helical contour in a circumferential direction configured to extend about a rotational axis of an impeller of the blower. For example, the first piece of sheet metal may be shaped via a cold forming process, or by heating the first piece of sheet metal to relax a rigidity of the first piece of sheet metal. The first piece of sheet metal may be curved to include a circular portion, to include a spiral or helical portion, or both. The opposing edges of the wrapper follow the circular, spiral, or helical curvature noted above.

The method 200 also includes forming (block 204), via a second piece of sheet metal, a side wall having a generally or partially U-shaped cross-sectional profile extruded about a curvature similar to, or the same as, the curvature of the opposing edges of the wrapper. In other words, the U-shaped cross-sectional profile is extruded along the circular, spiral, and/or helical portion(s) of the edge of the wrapper, although the U-shaped cross-sectional profile may change along the extrusion. For example, as previously described, a mouth of the U-shaped cross-sectional profile may gradually increase in size as the U-shaped profile approaches an air output opening of the blower, thereby facilitating a larger cross-sectional area of the flow path adjacent the air output opening.

The method 200 also includes coupling (block 206) the side wall to one of the opposing edges of the wrapper such that an inner transition region between the wrapper and the side wall, which forms at least a portion of the flow path of the blower, is rounded and not pointed. By facilitating smooth, rounded curves along the inner transition region between the wrapper and the side wall, secondary flows caused by pointed seams of traditional embodiments are reduced or negated. The method 200 may also include positioning (block 208) an impeller in the blower such that the impeller is fluidly coupled to an air intake opening through the side wall. As the impeller is rotated, for example by a motor, air is drawn into the flow path of the blower through the air intake opening, and the air is directed toward an air output opening for routing to a downstream HVAC application.

In accordance with the present disclosure, a blower includes a housing having smooth, rounded inner transition regions between a side wall of the housing and a wrapper of the housing, as described in detail above. By including the rounded inner transition regions, secondary air flows within a flow path of the blower are reduced, and an efficiency of the blower is improved. That is, by reducing or negating secondary air flows against a primary air flow in the flow path of the blower, a required power to a motor of the blower is reduced compared to traditional embodiments, thereby enhancing an efficiency of the disclosed blower.

While only certain features and embodiments of the disclosure have been illustrated and described, many modifications and changes may occur to those skilled in the art, such as variations in sizes, dimensions, structures, shapes and proportions of the various elements, values of parameters including temperatures and pressures, mounting arrangements, use of materials, colors, orientations, etc., without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described, such as those unrelated to the presently contemplated best mode of carrying out the disclosure, or those unrelated to enabling the claimed disclosure. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A blower, comprising:
an impeller configured to be turned about a rotational axis of the impeller; and
a housing comprising a wrapper which curves in a circumferential direction about the rotational axis, and comprising a side wall coupled to an edge of the wrapper such that an inner transition region between the side wall and the wrapper, which at least partially forms a flow path of the blower between an inlet and an outlet of the blower, is rounded and not pointed.

2. The blower of claim 1, wherein the side wall comprises a U-shaped cross-sectional profile with respect to a cross-section of the blower taken to include the rotational axis therein, and wherein the U-shaped cross-sectional profile of the side wall extends between the edge of the wrapper and the impeller.

3. The blower of claim 1, wherein the inner transition region comprises a U-shaped cross-sectional profile with respect to a cross-section of the blower taken to include the rotational axis therein.

4. The blower of claim 1, wherein the side wall comprises a flange, and wherein the wrapper comprises an outer ridge forming an inner recess in which the flange of the side wall is disposed to couple the side wall to the wrapper.

5. The blower of claim 4, comprising a crimping engagement between the outer ridge and the flange.

6. The blower of claim 4, comprising a weld between the outer ridge and the flange.

7. The blower of claim 1, comprising an air intake opening about which the side wall circumferentially extends, wherein the impeller is in fluid communication with the air intake opening and configured to draw air into the flow path of the blower through the air intake opening.

8. The blower of claim 1, comprising an air output opening, wherein a radial dimension of the flow path relative to the rotational axis of the impeller increases in size as the flow path approaches the air output opening.

9. The blower of claim 8, wherein the inner transition region between the side wall and the wrapper comprises a curvature which increases in obtuseness as the inner transition region extends about the impeller and approaches the air output opening.

10. The blower of claim 1, wherein the wrapper comprises a first piece of sheet metal, and wherein the side wall comprises a second piece of sheet metal.

11. The blower of claim 1, comprising an opposing side wall coupled to an opposing edge of the wrapper such that an additional inner transition region between the opposing side wall and the wrapper, which at least partially forms the flow path of the blower, is rounded and not pointed.

12. The blower of claim 1, wherein the inner transition region comprises a flat segment of the wrapper.

13. The blower of claim 1, wherein the side wall comprises an outer ridge forming an inner recess therein, wherein the wrapper comprises a flange, and wherein the flange is disposed within the inner recess of the outer ridge to couple the side wall to the wrapper.

14. The blower of claim 1, wherein the wrapper curves in the circumferential direction about the rotational axis along a spiral contour.

15. A blower, comprising:
an impeller configured to be turned about a rotational axis of the impeller; and
a housing comprising a wrapper having an edge that curves in a circumferential direction about the rotational axis and along a spiral contour, and comprising a side wall coupled to the edge of the wrapper, wherein the wrapper comprises an outer ridge extending along the edge and forming an inner recess therein, wherein the side wall comprises a flange, and wherein the flange is disposed in the outer ridge to couple the side wall to the wrapper such that an inner transition region between the side wall and the wrapper, which at least partially forms a flow path of the blower, is rounded and not pointed.

16. The blower of claim 15, comprising a weld between the outer ridge and the flange.

17. The blower of claim 15, comprising a crimping engagement between the outer ridge and the flange.

18. The blower of claim 15, wherein the side wall, the inner transition region, or both form a U-shaped cross-sectional profile with respect to a cross-section having the rotational axis therein, and wherein the U-shaped cross-sectional profile is disposed between the impeller and a segment of the wrapper.

19. The blower of claim 15, wherein the wrapper comprises a first piece of sheet metal, and wherein the side wall comprises a second piece of sheet metal.

20. The blower of claim 15, comprising an air intake opening about which the side wall extends, wherein the impeller is fluidly coupled to the air intake opening and configured to draw air into the flow path of the blower through the air intake opening.

21. A heating, ventilation, and air conditioning (HVAC) system comprising a blower, wherein the blower comprises:
an impeller configured to be turned about a rotational axis of the impeller; and
a housing comprising a wrapper that curves in a circumferential direction about the rotational axis, and comprising a side wall coupled to an edge of the wrapper such that an inner transition region between the side wall and the wrapper, which at least partially forms a flow path of the blower, is rounded and not pointed, and wherein the side wall, the inner transition region, or both form a U-shaped cross-sectional profile with respect to a cross-section having the rotational axis disposed therein.

22. The HVAC system of claim 21, wherein the wrapper comprises an outer ridge extending along the edge of the wrapper and forming an inner recess therein, wherein the side wall comprises a flange, and wherein the flange is disposed in the outer ridge to couple the side wall to the wrapper.

23. The HVAC system of claim 22, wherein the blower comprises a weld between the outer ridge and the flange, or wherein the blower comprises a crimping engagement between the outer ridge and the flange.

24. The HVAC system of claim 21, wherein the wrapper comprises a first piece of sheet metal, and wherein the side wall comprises a second piece of sheet metal.

25. The HVAC system of claim 21, wherein the wrapper curves in the circumferential direction about the rotational axis along a spiral contour.
